(19) United States
(12) Patent Application Publication
(10) Pub. No.: US 2013/0185424 A1
(43) Pub. Date: Jul. 18, 2013

(54) APPARATUS, METHOD AND SYSTEM FOR MANAGING EVENT INFORMATION

(71) Applicant: SAMSUNG ELECTRONICS CO., LTD., Suwon-si (KR)

(72) Inventors: Ho JIN, Yongin-Si (KR); Young-chul SOHN, Seoul (KR)

(73) Assignee: SAMSUNG ELECTRONICS CO., LTD., Suwon-si (KR)

(21) Appl. No.: 13/789,290

(22) Filed: Mar. 7, 2013

Related U.S. Application Data
(63) Continuation of application No. 11/643,807, filed on Dec. 22, 2006.

(30) Foreign Application Priority Data
Apr. 6, 2006 (KR) 10-2006-0031651

(51) Int. Cl. H04L 12/26

(52) U.S. Cl. CPC H04L 43/08
USPC 709/224

(57) ABSTRACT

An apparatus, method, and system for managing event information are provided. The apparatus for managing event information includes an event management module which receives event information on an event generated in an event generator located in the same network in a multicast manner, and manages the received event information, a storage module which stores the received event information, and a control module which controls the event generator. The event management module provides the received event information to an event-management-requesting device which requests storage of event information.

### CROSS-REFERENCE TO RELATED APPLICATION

This application is a continuation of U.S. Ser. No. 11/643,807 filed Dec. 22, 2006, which claims priority from Korean Patent Application No. 10-2006-0031651 filed on Apr. 6, 2006, in the Korean Intellectual Property Office, the disclosure of which is incorporated herein by reference in its entirety.

### BACKGROUND OF THE INVENTION

1. Field of the Invention

Methods, apparatuses and systems consistent with the present invention relate to managing event information and, more particularly, to collecting event information generated in devices included in a network, such as a home network in which a domain is created, and providing the event information to users.

2. Description of the Related Art

Recently, with the development of communication and network technologies, various types of home networks have appeared, and a technology for increasing user convenience in controlling and monitoring several devices included in a home network has been proposed.

In particular, a technology of collecting and providing event information generated in each device (for example, indicating the state of each device, such as starting the recording of a program received by a set-top box at a certain time set by a user or ending the operation of a washing machine) to the user has been proposed such that the user can easily recognize the state of each device.

One representative example of such technology is a home network based on Universal Plug and Play (UPnP) technology. Event information generated in each device included in the home network is provided to a user through the procedure illustrated in FIG. 1.

FIG. 1 is a schematic flowchart of the procedure for providing event information using related art UPnP technology.

At this time, the controlling device in FIG. 1 changes the state of other devices included in the home network according to user input, or receives information on the change of state generated by other devices. A controlled device is controlled by the controlling device, and provides information on the generated event to the controlling device through a predetermined procedure. Here, the controlling device and the controlled device are in the same home network.

Referring to FIG. 1, the controlling device requests the controlled device to perform event registration in order to receive an event generated in the controlled device (S110). The event registration request may be performed in response to an input from a user who uses the controlling device, or may be automatically performed when the controlling device starts operating.

The controlled device responds to the event registration request (120). The controlled device transmits an initial event message including information on its current state to the controlling device (S130).

After operation S130, when an event indicating the state change of the controlled device is generated (S140), the controlled device transmits an event message including information on the generated event to the controlling device (S150). At this time, when a plurality of events are generated at the same time, the controlled device may embed information on all of the events into a single event message, and transmit the single event message to the controlling device.

Therefore, the controlling device interprets the transmitted event message and provides the information on the event generated in the controlled device to a user.

However, in such a case above, the controlling device must request the controlled device to perform the event registration in order to obtain information on an event generated in the controlled device. Accordingly, the problem may occur that event information generated in the controlled device cannot be acquired by the device incapable of issuing an event registration request. If the controlling device and the controlled device are not in the same home network, the controlling device cannot receive the event information generated in the controlled device despite having an event registration request function.

Also, even if the controlling device performs the event registration request based on the UPnP technology, the event information generated in the controlled device cannot be received if the power of the controlling device is off. For example, assume the situation when a user instructs a personal video recorder (PVR) to perform reservation recording by using a personal data assistant (PDA) and then turns off the power of a PDA. In this case, if the PVR fails to perform the reservation recording and is to transmit the event of fail, the PDA cannot receive the event information because the power is off.

A method of receiving event information generated by the controlled device is required, even when the event registration request based on UPnP cannot be performed, or the controlling device and controlled device are not included in the same home network.

### SUMMARY OF THE INVENTION

The present invention provides an apparatus, method and system which collect event information generated in a device such as a controlled device, and provide an event-information-managing apparatus that provides the event information, thereby allowing the event information to be shared efficiently.

This and other aspects of the present invention will become clear to those skilled in the art upon review of the following description, attached drawings and appended claims.

According to an aspect of the present invention, there is provided an apparatus for managing event information, the apparatus including: an event management module which receives event information on an event generated in an event generator located on an identical network in a multicast manner and manages the received event information, a storage module which stores the received event information, and a control module which controls the event generator. The event management module provides the received event information to the event-management-requesting device that requested the storage of the event information.

According to another aspect of the present invention, there is provided an apparatus for managing event information, the apparatus including: an even management module which receives event information on an event generated in an event generator connected to the Internet, and manages the received event information, and a storage module which stores the received event information. The event management module provides the received event information to an event-management-requesting device which requested for the storage of the event information.

According to another aspect of the present invention, there is provided a method of managing event information, the method including: receiving event information on an event generated in an event generator located in the same network in a multicast manner, storing the received event information, and providing the received event information to an event-management-requesting device that requested for the storage of the event information.

According to another aspect of the present invention, there is provided a method of managing event information, the method including: receiving event information on an event generated in an event generator connected to the Internet, storing the received event information, and providing the received event information to an event-management-requesting device that requested the storage of the event information.

According to another aspect of the present invention, there is provided a system for managing event information, the system including: an event generator, an apparatus for managing event information which receives event information on the event generated by the event generator, and an event-management-requesting device which receives the event information from the event-information-managing apparatus and provides it to a user.

### BRIEF DESCRIPTION OF THE DRAWINGS

The above and other aspects of the present invention will become more apparent by describing in detail exemplary embodiments thereof with reference to the attached drawings, in which:

FIG. 1 is a flowchart illustrating a procedure of acquiring event information using related art technology;

FIG. 2 is a block diagram illustrating a system for providing event information according to an exemplary embodiment of the present invention;

FIG. 3 is a block diagram illustrating a configuration of an apparatus for managing event information which manages event information according to an exemplary embodiment of the present invention;

FIG. 4 is a flowchart illustrating a method for managing event information according to an exemplary embodiment of the present invention;

FIG. 5 is a flowchart illustrating a method for managing event information according to another exemplary embodiment of the present invention; and

FIG. 6 illustrates an event log information table according to an exemplary embodiment of the present invention.

### DETAILED DESCRIPTION OF EXEMPLARY EMBODIMENTS OF THE INVENTION

Advantages and features of the aspects of the present invention and methods of accomplishing the same may be understood more readily by reference to the following detailed description of exemplary embodiments and the accompanying drawings. The aspects of the present invention may, however, be embodied in many different forms and should not be construed as being limited to the embodiments set forth herein. Rather, these exemplary embodiments are provided so that this disclosure will be thorough and complete and will fully convey the concept of the invention to those skilled in the art, and the present invention will only be defined by the appended claims.

The present invention is described hereinafter with reference to flowchart illustrations of user interfaces, methods, and computer program products according to exemplary embodiments of the invention. It will be understood that each block of the flowchart illustrations, and combinations of blocks in the flowchart illustrations, can be implemented by computer program instructions. These computer program instructions can be provided to a processor of a general purpose computer, special purpose computer, or other programmable data processing apparatus to produce a machine, such that the instructions, which execute via the processor of the computer or other programmable data processing apparatus, create means for implementing the functions specified in the flowchart block or blocks.

These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks.

The computer program instructions may also be loaded into a computer or other programmable data processing apparatus to cause a series of operational steps to be performed in the computer or other programmable apparatus to produce a computer implemented process such that the instructions that execute on the computer or other programmable apparatus provide steps for implementing the functions specified in the flowchart block or blocks.

In addition, each block of the flowchart illustrations may represent a module, segment, or portion of code, which comprises one or more executable instructions for implementing the specified logical function(s). It should also be noted that in some alternative implementations, the functions noted in the blocks may occur out of order. For example, two blocks shown in succession may in fact be executed substantially concurrently or the blocks may sometimes be executed in the reverse order, depending upon the functionality involved.

The term “event” used in the present specification, indicates several changes of a state generated in a device included in a home network (for example, starting or terminating the recording of a program in a set-top box, or stopping a DVD). Various events may be generated depending on the types of devices. In addition, the term “event” used in the present specification may indicate an update of information provided from the device connected to home network through the Internet even though it is not included in home network.

The term “event information” indicates information on an event such as identification information on a device that generates the event, the time at which the event is started, and the content of the event.

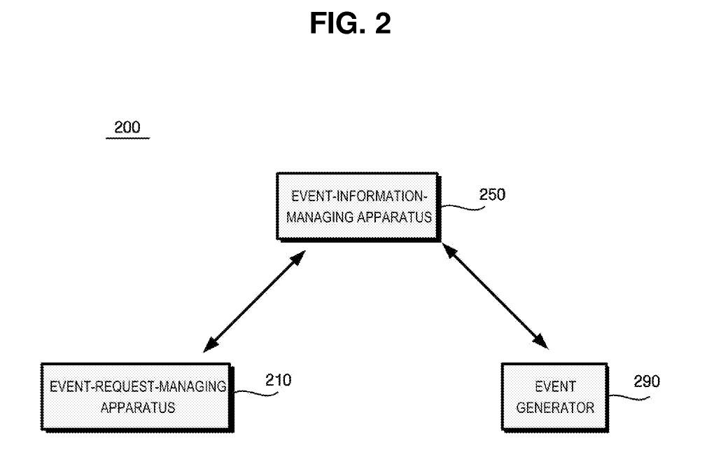

FIG. 2 is a block diagram showing a system for providing event information according to an exemplary embodiment of the present invention. A system for managing event information 200 includes an event-management-requesting device 210, an event-information-managing device 250, and an event generator 290.

The event-management-requesting device 210 and the event-information-managing device 250 are separated in FIG. 2, but they can be integrated into a single device.

In addition, the event-management-requesting device 210, the event-information-managing device 250, and the event generator 290 are included in a single home network, but they are not limited thereto.

That is, only the event-information-managing device 250 and the event generator 290 can be included in a single home network. In such a case, the event-management-requesting device 210 may be a portable mobile device accessible to the event-information-managing device 250, or a terminal remotely accessible to the event-information-managing device 250. In addition, in this case, the event-information-managing device 250 operates as a gateway in the home network.

The event-information-managing device 250 and the event generator 290 may reside in different networks. For example, the event-information-managing device 250 and the event-management-requesting device 210 can reside in a single home network, and the event generator 290 can be connected to the event-information-managing device 250 through the Internet. In this case, location information of the event generator 290, for example universal resource locator (URL) information, is stored in the event-information-managing device 250, and the event-information-managing device 250 can access the event generator 290 using the stored URL through the Internet. As another exemplary embodiment of the present invention, the event generator 290 can be connected to the event-information-managing device 250 through the Internet by accessing the URL of the event-information-managing device 250 which has been defined above.

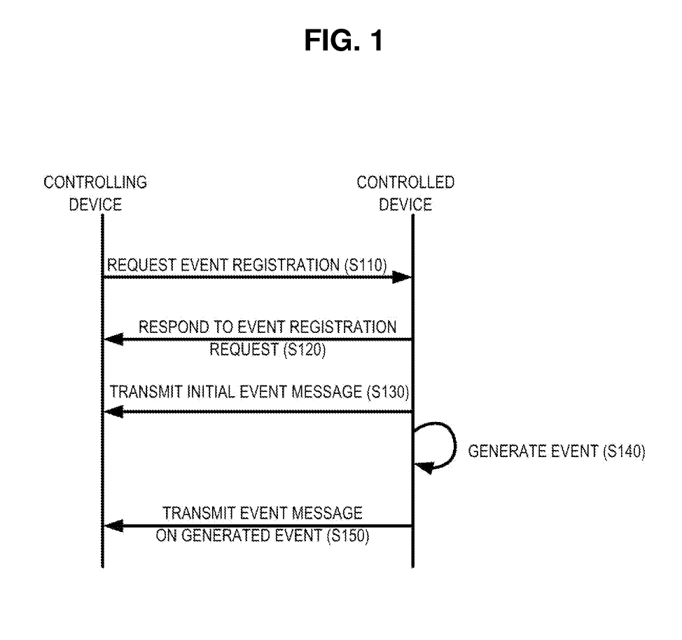

The event-management-requesting device 210 includes the devices which do not use UPnP technology, as well as controlling devices in the home network based on the UPnP technology as illustrated in FIG. 1.

The event-management-requesting device 210 collects the information on an event generated in the event generator 290 with respect to the event-information-managing device 250 according to a user input, or when the event-management-requesting device 210 starts operating, and then requests to provide the collected information.

The event-information-managing device 250 collects the event information generated in the event generator 290, and provides the collected event information to the event-management-requesting device 210 according to the request of the event-management-requesting device 210.

The event-information-managing device 250 can control the event generator 290, and provide the event information according to the event generator 290 to the event-management-requesting device 210.

The event generator 290 is controlled by the event-information-managing device 250, and the information on the event generated in the event generator 290 can be transmitted to the event-information-managing device 250 according to the control. At this time, the event information may be transmitted in a multicast manner. When the event generator 290 is connected to the event-information-managing device 250 through the Internet and information is updated in the event generator 290 (for example, if the event generator 290 provides information on stock or weather and the corresponding information is updated), the updated information can be provided to the event-information-managing device 250 as the event information. Here, the information on stock or weather can be updated every day or every week, and the updated period can be pre-set by the event generator 290.

The operation of the system 200 illustrated in FIG. 2 will be described in detail below.

The event-management-requesting device 210 requests the event-information-managing device 250 to manage the information on the event generated in the event generator 290. At this time, the event-management-requesting device 210 can perform UPnP communication with the event-information-managing device 250, or communicate using a pre-set protocol.

When an event is generated in the event generator 290, an event message including event information on the generated event is transmitted to the event-information-managing device 250. At this time, the event message can be transmitted in a multicast manner.

The event-information-managing device 250 extracts the event information from the transmitted event message and transmits it to the event-management-requesting device 210, or it may store the extracted event information so that it can be provided according to the request of the event-management-requesting device 210.

The event-management-requesting device 210 may display the event information received from the event-information-managing device 250, or provide the event information to a user by outputting it as sound.

If the event generator 290 is connected to the event-information-managing device 250 through the Internet, the event generator 290 can transmit the information updated according to the request of the event-information-managing device 250 as event information to the event-information-managing device 250.

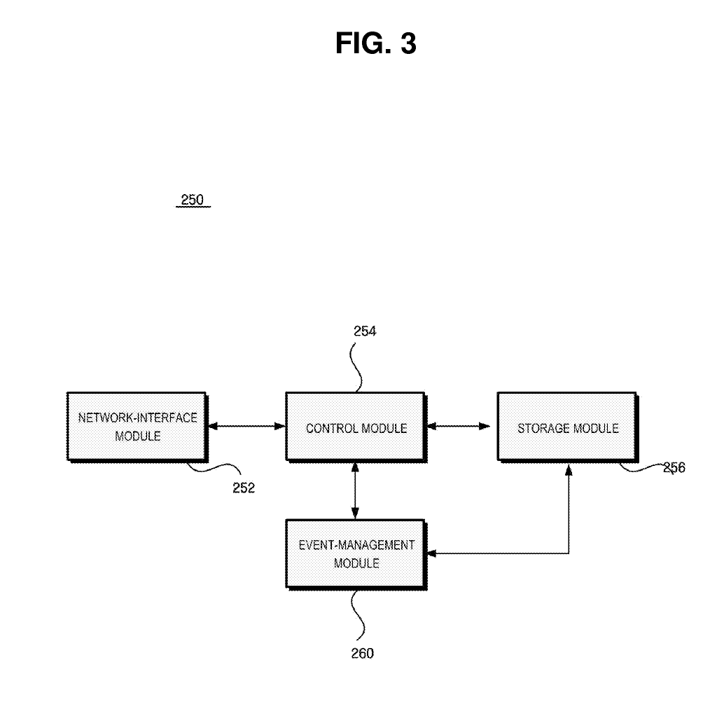

FIG. 3 is a block diagram illustrating a configuration of an apparatus for managing event information according to an exemplary embodiment of the present invention.

Referring to FIG. 3, the event-information-managing device 250 includes a network interface module 252, a control module 254, a storage module 256, and an event management module 260.

The network interface module 252 performs the communication with the event-management-requesting device 210 or with the event generator 290 via a wire or wireless connection.

With respect to event information management, the control module 254 interprets the message received via the network interface module 252, or generates a message to be transmitted to the event-management-requesting device 210 or event generator 290 to transmit the message via the network interface module 252.

The event management module 260 interprets the event message received from the event generator 290, stores the event information on the generated event into the storage module 256, and manages the stored event information. Then, the event management module 260 extracts the event information stored in the storage module 256 and provides the event information to the control module 254 according to the request of the event-management-requesting device 210, and the control module 254 generates message for providing event log information based on the extracted information and transmits the message to the event-management-requesting device 210 through the interface module 252.

The control module 254 and the event management module 260 can operate as a single module.

The storage module 256 stores the event information on the event generated in the event generator 290.

The term “module”, as used herein, means, but is not limited to, a software or hardware component, such as a Field Programmable Gate Array (FPGA) or an Application Specific Integrated Circuit (ASIC), which performs certain tasks. A module may advantageously be configured to reside on the addressable storage medium and to execute on one or more processors. Thus, a “unit” may include, by way of example, components, such as software components, object-oriented software components, class components and task components, process, functions, attributes, procedures, subroutines, segments of program code, drivers, firmware, microcode, circuitry, data, databases, data structures, tables, arrays, and variables. The functionality provided for in the components and modules may be combined into fewer components and modules or further separated into additional components and modules.

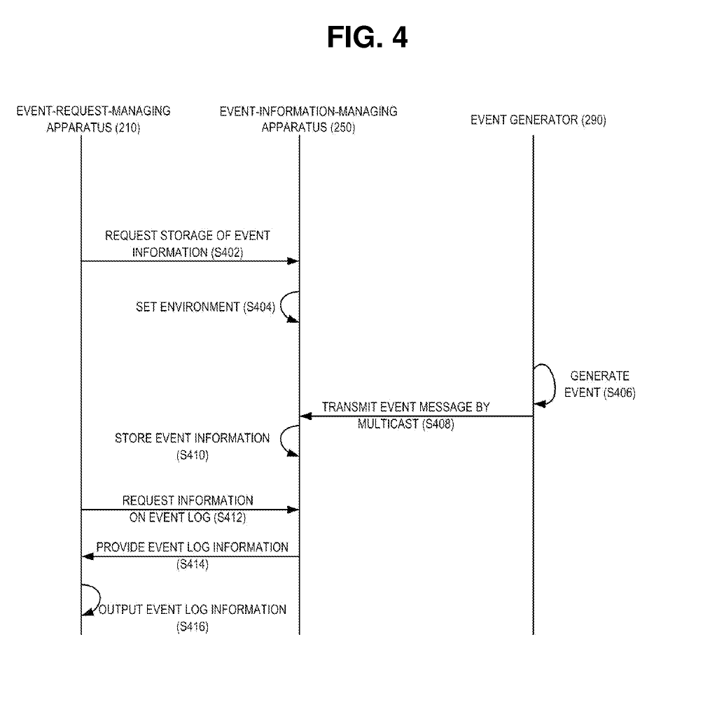

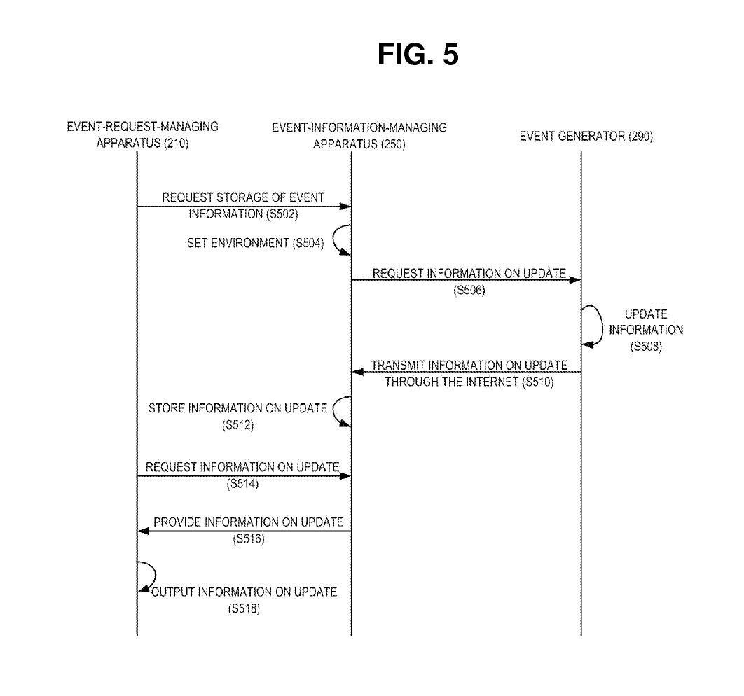

The operation of each module illustrated in FIG. 3 will be described in detail according to the flowchart illustrated in FIGS. 4 and 5. FIG. 4 illustrates the operation performed when the event generator 290 is included in the network, which also includes the event-information-managing device 250. FIG. 5 illustrates the operation performed when the event generator 290 is connected to the event-information-managing device 250 through the Internet.

Referring to FIG. 4, the event-management-requesting device 210 requests the event-information-managing device 250 to store the event information generated in the event generator 290 (S402).

Meanwhile, the user may set the event-information-managing device 250 to automatically manage the event generated in every device existing on the network. In this case, the event-information-managing device 250 can manage the event without the request to store the event information performed from the event-management-requesting device 210.

According to the request, the control module 254 of the event-information-managing device 250 sets the environment for storing the event information (S404). For example, the control module 254 can establish the environment where the corresponding information can be stored in the storage module 256 according to the time at which the event is started, the event generator from which the event is generated, or the type of the event.

When a user requests the event-management-requesting device 210 to store the event information, the information on setting the environment is provided so that the environment where the event information is stored can be established in a format desired by a user.

After the environment is established, if the event, such as, the state change of the device in the event generator 290 (for example, ending the operation of a DVD player, or generating errors) is generated (S406), the event generator 290 transmits the event message including the event information on the generated event to the event-information-managing device 250 in a multicast manner (S408).

At this time, the event information may include a parameter indicating the state change of the event generator and the parameter value, and the information may be transmitted in a frame format or a structured text format, like the extensible markup language (XML).

The event message transmitted from the event generator 290 may include a multicast Internet Protocol (IP) address and port information for the transmission in multicast, information on an event type, and identification information on the event message for preventing repeated message reception as a result of the multicast transmission and identification information on the device generated by event.

At this time, info, fault, warning, and emergency are examples of event types.

The control module 254 of the event-information-managing device 250 transmits the event message received through the network interface module 252 to the event management module 260. The event management module 260 interprets the event message and stores the event information in the storage module 256 according to the environment set during operation S404 (S410).

Whenever the event is generated in the event generator 290, the corresponding event information is transmitted to the event-information-managing device 250 in a multicast manner. Therefore, log information on the event information is left in the storage module 256.

The event-information-managing device 250 stores the event information generated for a predetermined period of time, or selectively stores the received event information. Accordingly, the corresponding environment can be established in operation S404.

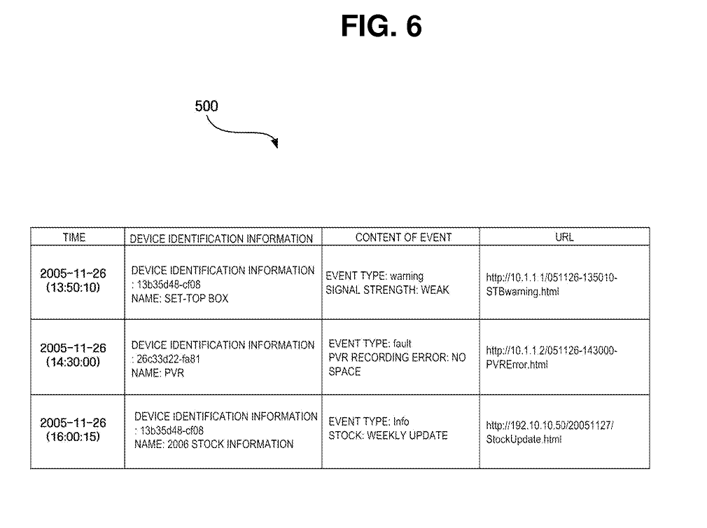

FIG. 6 illustrates an example indicating log information stored in the storage module 256.

Referring to FIG. 6, the time at which the event is started, the type of the event generator, the type of the event, and the URL information of the event generator in which the event generated are recorded in a log information table 500.

Log information stored in the log information table 500 may be stored, searched, or filtered by the control module 254 or the event management module 260, and the result of storing, searching, and filtering may be provided to a user through the event-management-requesting device 210.

After the event information is stored in the storage module 256, the event-management-requesting device 210 requests the event-information-managing device 250 for the log information (S412). In the response, the event management module 260 extracts the event log information from the storage module 256 and provides it to the event-management-requesting device 210 (S414).

The event-management-requesting device 210 can sort event log information by event generators, event types, or event generation times when providing it to the user and can also allow the user to search events.

The event log information can be transmitted to the event-management-requesting device 210 at once or in a regular term without the request from the event-management-requesting device 210 whenever new event information with respect to the event generation is stored in the event-information-managing device 250.

Whenever an event is generated by the event generator 290, the information on the generated event is transmitted to the event-information-managing device 250 in a multicast manner, thereby allowing the user to access the event-information-managing device 250 whenever the user wants to receive event log information by using the event-management-requesting device 210.

Referring to FIG. 5, the event-management-requesting device 210 requests the event-information-managing device 250 to store the event information generated in the event generator 290 (S502).

According to the request, the control module 254 of the event-information-managing device 250 establishes an environment for storing event information (S504). In this case, the environment can be established according to the method described in operation S404 of FIG. 4.

The event-information-managing device 250 stores location information, e.g., URL information, of the event generator 290 in the storage module 256. Accordingly, after accessing the event generator 290 through the Internet by using the location information, the event-information-managing device 250 requests information on the update performed in the event generator 290 (S506). As another exemplary embodiment, the event generator 290 and the event-information-managing device 250 can be connected to each other through the Internet by accessing the URL of the event-information-managing device 250, which is already defined.

When the information is updated in the event generator 290 (S508), the updated information is transmitted to the event-information-managing device 250 through the Internet (S510). In this case, the transmitted information on the update corresponds to event information included in the event message described in FIG. 4.

The control module 254 of the event-information-managing device 250 transmits the event message received through the network interface module 252 to the event management module 260, and the event management module 260 interprets the event message and stores the event information in the storage module 256 according to the environment set in operation S504 (S512).

Whenever an event generates in the event generator 290, the corresponding event information may be transmitted to the event-information-managing device 250. Therefore, the log information with respect to the event information is left in the storage module 256.

After the event information is stored in the storage module 256 and when the event-management-requesting device 210 requests the event-information-managing device 250 for the log information (S514), the event management module 260 extracts the event log information from the storage module 256 and provides it to the event-management-requesting device 210.

The event-management-requesting device 210 can provide the log information received from the event-information-managing device 250 to the user by displaying the log information or by outputting a sound signal (S518).

The event-management-requesting device 210 can sort event log information by event generators, event types, or event generation times when providing it to the user and can also allow the user to search event information.

The home network is used as an example to describe the present invention, but this is just exemplary. It should be obvious to those of ordinary skill in the art that the present invention can be applied to the network physically and logically distinguished.

According to the exemplary embodiments, when the UPnP event registration request cannot be performed, or the event is performed through a device not included in the network, the event information generated by the event generator can be received.

According to the exemplary embodiments, event information can be managed more effectively.

The exemplary embodiments of the present invention have been described for illustrative purposes, and those skilled in the art will appreciate that various modifications, additions and substitutions are possible without departing from the scope and spirit of the invention as disclosed in the accompanying claims. Therefore, the scope of the present invention should be defined by the appended claims and their legal equivalents.

What is claimed is:

1. A method of managing event information, the method comprising:
requesting an event-information managing apparatus to store event information on an event generated in an event generator;
requesting the event information stored in the event-information managing apparatus to be transmitted;
receiving the requested event information from the event-information managing apparatus; and
providing the received event information to a user,
wherein the event-information managing apparatus and the event generator belong to the same network.

2. The method of claim 1, wherein the event information comprises information on a time the event was generated.

3. The method of claim 1, wherein the event information comprises information on contents of the generated event.

4. The method of claim 1, wherein the event information comprises identification information on the event generator generating the event.

5. The method of claim 1, wherein said receiving the event information from the event-information managing apparatus further comprises receiving event log information including a plurality of pieces of event information stored in the event-information managing apparatus.

6. The method of claim 1, wherein the event information comprises update information provided from the event generator.

7. The method of claim 1, wherein the event information is transmitted to be included in an event message generated by the event generator, and the event message comprises a multicast Internet protocol (IP) address and port information for multicast transmission and identification information on the event message.
